(19) United States
(12) Patent Application Publication
(10) Pub. No.: US 2008/0006479 A1
(43) Pub. Date: Jan. 10, 2008

(54) Ladder level indicator

(76) Inventor: Elizabeth L. Mabry, Stevensville, MI (US)

Correspondence Address: SUNG I. OH, PROFESSIONAL LAW CORPORATION, 710 QUAIL VALLEY LANE, WEST COVINA, CA, 91791, US

(21) Appl. No.: 11/481,981

(22) Filed: Jul. 6, 2006

(51) Int. Cl. E06C 5/44

(52) U.S. Cl. 182/18

(57) ABSTRACT

A device used to ensure that a ladder is properly leveled includes an L-shaped base having one arm oriented at a right angle with respect to a second arm in one plane and at a 75° angle with respect to the second arm in a second plane. One arm includes a clip element for releasable attachment to a ladder. Bubble levels are located in each arm and are used to ensure that a ladder on which the device is mounted is level in two planes.

### TECHNICAL FIELD OF THE INVENTION

The present invention relates to the general art of ladders, and to the particular field of ladder leveling devices.

### BACKGROUND OF THE INVENTION

When a straight or extension ladder is positioned against a structure, it is essential that the ladder be properly angled to prevent slipping of the ladder feet. As a general rule, the base of the ladder should be positioned at a distance which is one-fourth of the working length thereof from the vertical support. If such positioning is not possible, the top and bottom of the ladder should be braces, tied, or otherwise secured for safety. This general rule, however, assumes that the base of the ladder is positioned on a level surface. This assumption is often not true in practice. When a ladder is positioned on a sloping surface, such as a roof, the angle between the ladder and the support surface is decreased from that when the surface is level with a corresponding decrease in the frictional holding ability of the ladder feet and, accordingly, a greater risk of the ladder slipping when in use.

Furthermore, Federal and state regulations require that a ladder be placed against a support surface at a safe angle which is defined as 75 degrees to the horizontal and 15 degrees to the vertical. The rule requirement is simple but the application of it is difficult and unreliable. One approach is to use a four to one ratio with the distance of the foot of the ladder from the vertical support being one unit for every four units of length of the ladder from its foot to the point on the ladder where it engages the vertical support. This system requires considerable measuring which allows for numerous errors to occur, making the system unreliable and the use of the ladder unsafe. Another approach is to have a person stand with the person's feet at the foot of the ladder and then the person's hands extended horizontally should touch the ladder if it is at a safe angle. A number of variables are present in the use of this system which makes it unreliable, such as arm length varies from person to person and if the person does not stand straight the test will be inaccurate.

It is thus apparent that a more practical and reliable system is needed to ensure that a ladder is safely positioned before it is used, both relative to the angle of the ladder to the wall supporting it and the angle of the ladder to the ground.

Furthermore, since the ground can have a very uneven surface, a desired orientation for a ladder at one location on the ground may not be desirable at another location. Therefore, any device used to ensure desired orientation of a ladder should be easily changed and moved on the ladder so various conditions can be accommodated.

### SUMMARY OF THE INVENTION

The above-discussed disadvantages of the prior art are overcome by device that includes an L-shaped base having one arm oriented at a right angle with respect to a second arm. One arm includes a clip element for releasable attachment to a ladder. Bubble levels are located in each arm and are used to ensure that a ladder on which the device is mounted is level in two planes. A single ladder can have a plurality of these devices mounted thereon, such as on the right rail as well as on the left rail, or even at a plurality of locations on each rail, so that a properly oriented ladder is fully ensured. The devices are easily mounted and dismounted on a ladder, yet will remain securely in place once mounted on the ladder. Thus, the devices can be placed and moved as required to ensure proper orientation of the ladder at all times.

Using the embodying the present invention will permit ensuring that a ladder is level in at least two planes whereby an uneven supporting terrain can be accommodated.

Other systems, methods, features, and advantages of the invention will be, or will become, apparent to one with skill in the art upon examination of the following figures and detailed description. It is intended that all such additional systems, methods, features, and advantages be included within this description, be within the scope of the invention, and be protected by the following claims.

### BRIEF DESCRIPTION OF THE DRAWING FIGURE

The invention can be better understood with reference to the following drawing and description. The components in the figure are not necessarily to scale, emphasis instead being placed upon illustrating the principles of the invention. Moreover, in the figure, like referenced numerals designate corresponding parts throughout the view.

FIG. 1 is a perspective view of a device used in conjunction with a ladder to ensure that the ladder is properly leveled embodying the present invention.

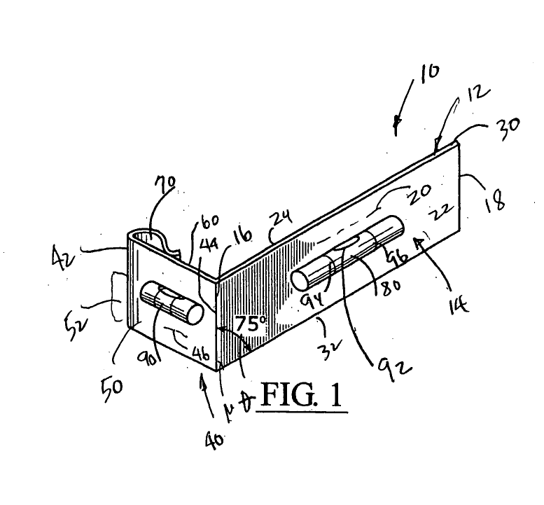

### DETAILED DESCRIPTION OF THE INVENTION

Referring to the figure, it can be understood that the present invention is embodied in a device 10 used to ensure that a ladder is properly leveled. Device 10 comprises an L-shaped body 12. Body 12 has a first leg 14 which will rest on one portion of the ladder, such as on one surface of a rail of the ladder. Leg 14 includes a first end edge 16, a second end edge 18 and a longitudinal axis 20 which extends between first end edge 16 and second end edge 18. Leg 14 further includes a first planar surface 22 which is an outside surface when the body is in use on a ladder and a second planar surface 24 which is an inside surface and which abuts the ladder when the body is in use on the ladder.

Leg 14 further includes a first side edge 30 which connects first end 16 to second end 18. First side edge 30 is a top side edge when the body is in use on the ladder. A second side edge 32 of leg 14 connects first end 16 to second end 18. Second side edge 32 is a bottom side edge when the body is in use on the ladder. Second side edge 32 is oriented at an angle θ with respect to the second end edge of the first leg. Angle θ is a 75° angle so the device will fit properly on a ladder.

Device 10 further comprises a second leg 40 which includes a first end edge 42 and a second end edge 44. Second end edge 42 of the second leg is unitary with first end edge 16 of the first leg. A longitudinal axis 46 extends between first end edge 42 of the second leg and second end edge 44 of the second leg. Longitudinal axis 46 of the second leg is oriented at a right angle with respect to longitudinal axis 20 of the first leg.

Second leg 40 further includes a first planar surface 50 which is an outside surface when the body is in use on a ladder. A plane 52 containing first planar surface 50 of the second leg is oriented at an angle μ with respect to a second side edge 32 of the first leg, with angle μ being a 75° angle so that first end edge 16 of the first leg lies in plane 52 of the second leg. In the form shown, angles μ and θ are identical.

Leg 40 further includes a second planar surface 60 which is an inside surface when the body is in use on the ladder and which abuts a surface of the ladder when the body is in use on the ladder. Second leg 40 is oriented at a right angle with respect to first leg 14. A hairpin-shaped clip 70 is unitary with first end 42 of second leg 40 and clips onto the ladder to hold device 10 on the ladder. A similar clip can be mounted on end 18 of the first leg if desired. As can be understood from the figure, the clips are spring clips and are biased to engage the inside surface of the leg associated therewith. The device is thus held on a ladder by wedging a ladder element between a clip and the leg associated therewith.

A first spirit level 80 is mounted on first planar surface 22 of first leg 14 and extends in the direction of longitudinal axis 20 of the first leg. A second spirit level 90 is mounted on first planar surface 50 of second leg 40 and extends in the direction of longitudinal axis 46 of the second leg.

Use of device 10 can be understood from the teaching of this disclosure and thus will be presented only briefly. Device 10 is mounted on a portion of a ladder, such as on a rail of a ladder so that the first leg is flush with the side surface of the rail, and the second leg is flush with the front surface of the rail. The orientation of the ladder is altered until the bubbles, such as bubble 92 of spirit level 80, of both spirit levels are within the center marks, such as center marks 94 and 96 of spirit level 80. The 75° angular orientations of the legs with respect to each other account for the angular orientation of the ladder with respect to an upright orientation whereby a ladder having device 10 thereon will be properly oriented with respect to the upright orientation. The right angle orientation of the legs of the device permit the device to be flush mounted on the surfaces of the ladder rail.

While various embodiments of the invention have been described, it will be apparent to those of ordinary skill in the art that many more embodiments and implementations are possible within the scope of this invention. Accordingly, the invention is not to be restricted except in light of the attached claims and their equivalents.

What is claimed is:

1. A device used to ensure that a ladder is properly leveled comprising:
A) an L-shaped body having
(1) a first leg which includes
(a) a first end edge,
(b) a second end edge,
(c) a longitudinal axis which extends between the first end edge of the first leg and the second end edge of the first leg,
(d) a first planar surface which is an outside surface when the body is in use on a ladder,
(e) a second planar surface which is an inside surface when the body is in use on the ladder,
(f) a first side edge which connects the first end of the first leg to the second end of the first leg, the first side edge being a top side edge when the body is in use on the ladder,
(g) a second side edge which connects the first end of the first leg to the second end of the first leg, the second side edge being a bottom side edge when the body is in use on the ladder,
(h) the second side edge being oriented at a 750 angle with respect to the second end edge of the first leg,
(2) a second leg which includes
(a) a first end edge,
(b) a second end edge, the second end edge of the second leg being unitary with the first end edge of the first leg,
(c) a longitudinal axis which extends between the first end edge of the second leg and the second end edge of the second leg, the longitudinal axis of the second leg being oriented at a right angle with respect to the longitudinal axis of the first leg,
(d) a first planar surface which is an outside surface when the body is in use on a ladder, a plane containing the first planar surface of the second leg being oriented at a 750 angle to the second side edge of the first leg,
(e) a second planar surface which is an inside surface when the body is in use on the ladder,
(f) the second leg being oriented at a right angle to the first leg,
(g) a hairpin-shaped clip which is unitary with the first end of the second leg;
C) a first spirit level mounted on the first planar surface of the first leg and extending in the direction of the longitudinal axis of the first leg; and
D) a second spirit level mounted on the first planar surface of the second leg and extending in the direction of the longitudinal axis of the second leg.

2. A device used to ensure that a ladder is properly leveled comprising:
A) an L-shaped body having two legs oriented at a right angle to each other in one plane and at a 75° angle with respect to each other in a second plane;
B) a clip on one leg; and
C) a spirit level on each leg, the spirit levels being oriented at a right angle with respect to each other.
